(19) United States
(12) Patent Application Publication
(10) Pub. No.: US 2025/0390423 A1
(43) Pub. Date: Dec. 25, 2025

(54) EXECUTABLE CODE FAULT DETECTION

(71) Applicant: Adobe Inc., San Jose, CA (US)

(72) Inventors: Charles Robert John Matthews, Edinburgh (GB); Thomas Stanley Dalton, St Andrews (GB); Harinder Singh Sandhu, Edinburgh (GB); Adrian John O'Lenskie, Dunblane (GB)

(73) Assignee: Adobe Inc., San Jose, CA (US)

(21) Appl. No.: 18/750,573

(22) Filed: Jun. 21, 2024

(51) Int. Cl. G06F 11/36; G06F 8/60

(52) U.S. Cl. CPC G06F 11/3688; G06F 8/60; G06F 11/3604

(57) ABSTRACT

Executable code fault detection techniques are described. In one or more implementations, a request is received to include a code unit as part of executable code and metadata is obtained that is associated with the code unit. A fault score is generated that is indicative of a probability that the code unit introduces a fault as part of execution with the executable code. The fault score is generated using a machine-learning model by processing the metadata. Testing of the code unit as part of the executable code is controlled based on the fault score.

### BACKGROUND

Executable code development, also known as “software development,” may involve teams of engineers that make incremental changes via respective code units. The code units are committed to isolated branches during “coding” of the code units, which are then merged into a production version of the executable code once complete. Before merging the code units, the code units are typically validated to protect against defects. Conventional techniques to do so, however, are inflexible, inaccurate, and costly both with respect to use of human resources as well as computational resources.

### SUMMARY

Executable code fault detection techniques are described. A code development system, for instance, utilizes a machine-learning model to generate a fault score that indicates a probability of a fault from a change caused by a code unit. To do so, the machine-learning model processes metadata associated with the code unit. Examples include metadata that describe a characteristic of the code unit, a characteristic of a programmer that originated the code unit, a characteristic of a repository, in which, the executable code is maintained, a characteristic of a reviewer that is to review the code unit, and so forth. Based on the fault score, the code development system is then configurable to control an amount of review to be undertaken before the code unit is incorporated by the executable code.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ executable code fault detection techniques described herein.

FIG. 2 depicts a system in an example implementation showing training of a machine-learning model of FIG. 1 in greater detail.

FIG. 3 is a flow diagram depicting an algorithm as a step-by-step procedure in an example implementation of operations performable for accomplishing a result of training a machine-learning model for executable code fault detection.

FIG. 4 depicts a system in an example implementation showing executable code fault detection by a machine-learning model as trained in FIG. 2 in greater detail.

FIG. 5 is a flow diagram depicting an algorithm as a step-by-step procedure in an example implementation of operations performable for accomplishing a result of executable code fault detection and review control.

FIG. 6 depicts an example implementation of a receiver operating character curve.

FIG. 7 depicts an example implementation of a cost/benefit curve.

FIG. 8 illustrates an example system including various components of an example device that can be implemented as any type of computing device as described and/or utilize with reference to the previous figures to implement embodiments of the techniques described herein.

### DETAILED DESCRIPTION

### Overview

Executable code development is a laborious process which may involve teams of engineers to create and/or update executable code in common usage scenarios. To do so, code units written by respective engineers are created using isolated branches of the executable code, which are then merged into a production version of the executable code for deployment. Before being merged, an administrator initiates a pull request (PR) and completes a validation workflow to ensure quality, which often includes code review by fellow developers, testing, and so forth.

The validation workflow, for instance, is implemented to give a layer of control and predictive insight as to a likely outcome of incorporation of the code unit as part of the executable code. In conventional techniques, quality gates are manually instituted to ensure changes made by the code units are consistent with a standard. The quality gates are utilized to promote consistency in a level of code validation across the executable code and a repository that is used to maintain the executable code. However, quality gates as implemented using conventional techniques are inflexible and inaccurate and therefore costly both with respect to use of human resources as well as computational resources used to implement the development and testing of the code units.

Accordingly, executable code fault detection techniques are described. A code development system, for instance, is configurable to generate a fault score that codifies an inherent statistical risk likely to occur from a change caused by a code unit and may do so without executing the code itself. The code development system may even do so in one or more examples independent of analysis of the code unit, itself, although analysis of the code unit is also supported.

To do so, the code development system processes metadata associated with the code unit using a machine-learning model to generate a fault score. The fault score is usable to quantify a probability that execution of the code unit will result in a fault. The code development system, for instance, is configurable to process metadata that describes a variety of characteristics associated with the code unit. Examples include metadata that describe a characteristic of the code unit, a characteristic of a programmer that originated the code unit, a characteristic of a repository, in which, the executable code is maintained, a characteristic of a reviewer that is to review the code unit, and so forth. For example, the metadata is configurable to provide information about a programmer that authored the code unit, a size and location of the code unit within the executable code, reviewers assigned to review the code unit, historical information about similar code units within the executable code, and so forth.

Based on the fault score, the code development system is then configurable to control an amount of review to be undertaken before the code unit is incorporated by the executable code. In this way, the code development system provides a tool for use in mitigating risk and for efficiently allocating resources utilized in code validation. The code development system is also configurable to automatically set quality gate thresholds (e.g., a number of reviewers) and may do so as part of a cost/benefit analysis based on a cost associated with a review and a cost associated with the fault. The code development system is further configurable to assign reviewers and provide a feedback mechanism to track evolution of the executable code and build discussion on how a number of fixes may be reduced in the future. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Executable Code Fault Detection Environment

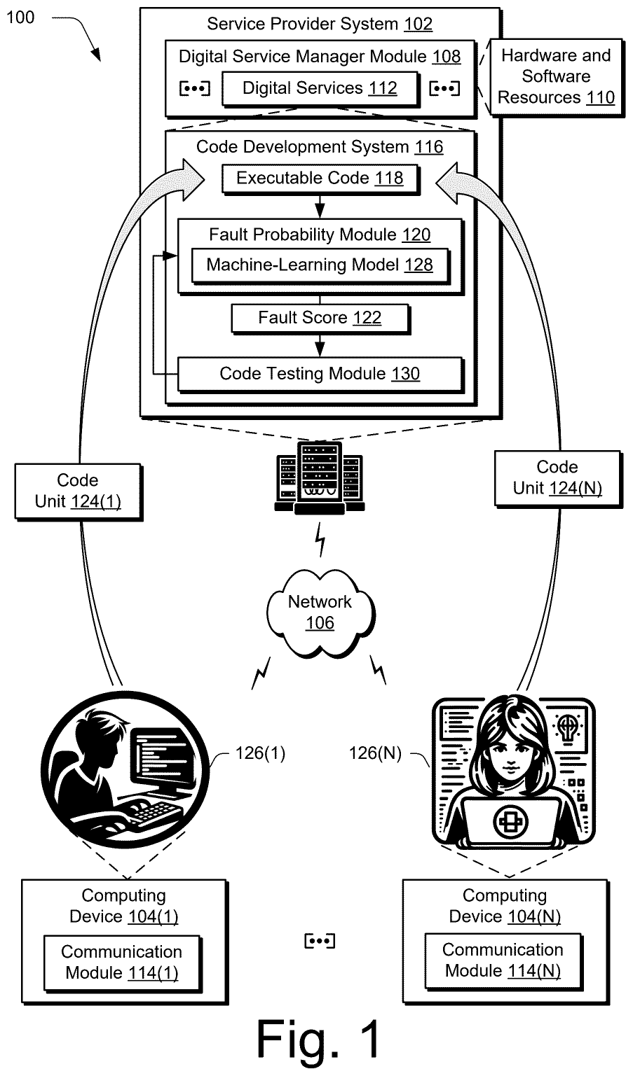

FIG. 1 is an illustration of a digital medium environment 100 in an example implementation that is operable to employ executable code fault detection techniques described herein. The illustrated environment 100 includes a service provider system 102 and a plurality of computing devices, examples of which are illustrated as computing device 104(1), . . . , computing device 104(N). The system and devices are communicatively coupled, one to another, via a network 106. Computing devices are configurable in a variety of ways.

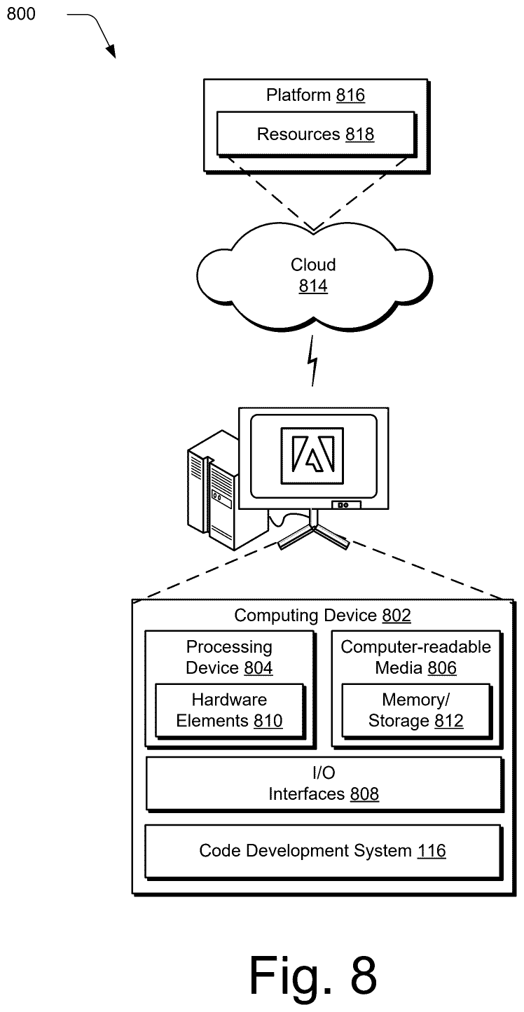

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 8.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing devices 104(1), 104(N).

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a code development system 116 that is configured to generate executable code 118, e.g., applications, plug-in-modules, software updates, and other instructions that are executable by a processing device to cause performance of one or more operations. As part of development of the executable code 118, the code development system 116 employs a fault probability module 120 that is configurable to generate a fault score 122. The fault score 122 is indicative of a probability that a respective code unit introduces a fault as part of execution with the executable code 118.

The computing devices 104(1), 104(N), for instance, are associated with respective entities 126(1), 126(N) (e.g., programmers, developers, reviewers, consumers, and so forth) that originate respective code units 124(1), 124(N) for incorporation with the executable code 118. The code units 124(1), 124(N) are configurable to include instructions that specify operations to be performed through execution by a processing device. The code units 124(1), 124(N) are therefore configurable in a variety of ways, such as to generate an initial instance of the executable code 118, form an update to the executable code 118, a different version of the executable code 118, and other examples.

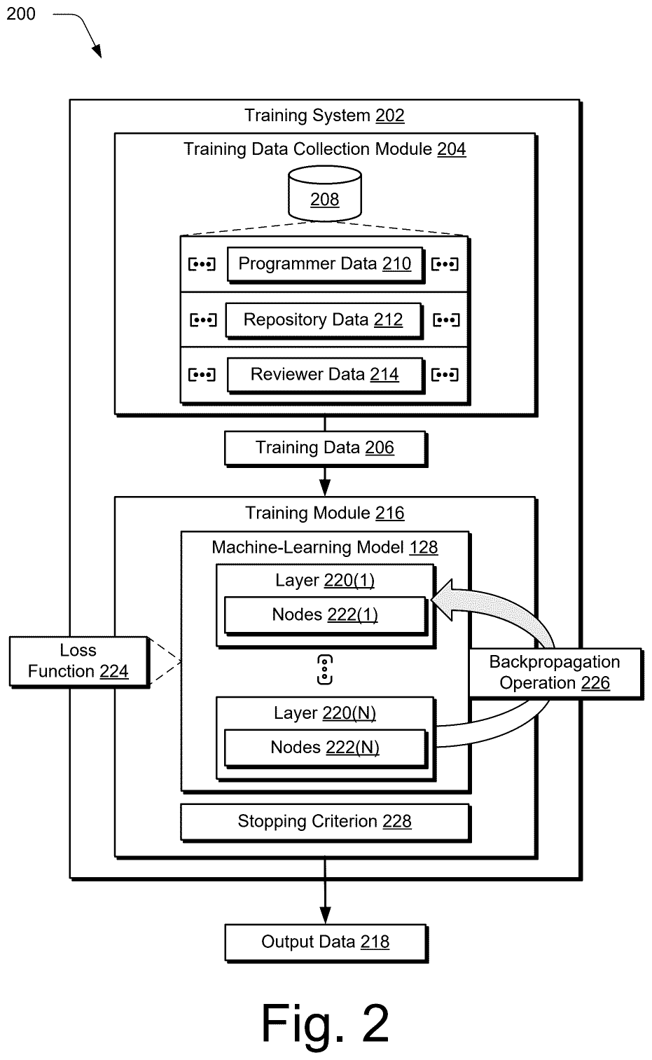

To do so, the fault probability module 120 employs a machine-learning model 128 to generate the fault score 122 based on metadata associated with the code units 124(1), 124(N). The metadata provides insights into characteristics of the code units 124(1), 124(N), the executable code 118 itself, entities 126(1), 126(N) that originated the code units (i.e., programmed the code units), a repository, in which the executable code 118 is maintained, reviewers and potential reviewers of the code units 124(1), 124(N), and so forth. The machine-learning model 128, for instance, is trainable as further described in relation to FIG. 2 based on training data that includes training metadata and associated outcomes involving and not involving faults in execution of respective training code units.

The machine-learning model 128 is therefore usable to identify patterns that are usable to quantify an amount of risk associated with the code units 124(1), 124(N) based on respective metadata. A code testing module 130 is then used in the illustrated example to control testing of the code units 124(1), 124(N) based on the fault score 122. The code testing module 130, for instance, is usable to assign a number of reviewers based on the fault score 122, assign reviewers based on qualifications of the reviewers, assign reviewers based on type of code, based on risk associated with a code type (e.g., root versus peripheral functions), select automated testing techniques having different investigative levels that involve different levels of computational resource consumption, and so forth. For example, the code testing module 130 is configurable to employ a cost/benefit analysis based on an amount of review to be performed and a risk associated with a likelihood that the code unit will cause a fault during execution of the executable code 118.

When code units 124(1), 124(N) are completed by the entities 126(1), 126(N) and ready for integration into the executable code 118, the code development system 116 triggers one or more validation tests to ensure compliance with corresponding quality gates. Quality gates include code review by reviewers, automated testing, code analysis, and so forth. Rigorousness of the testing is controlled by the code testing module 130 to balance risk introduced by making changes against a desire to continue code development. Risk includes a likelihood that a line of code in the change will cause a fault and therefore involve a further modification to fix within a time horizon, i.e., a defined amount of time. The fault probability module 120 quantifies this probability as a fault score 122 through training based on historical data that takes into account a level of risk (e.g., for sensitive code areas), amount of changes being made, and so forth.

In a first example scenario, a new item of executable code 118 is being authored. Even though a relatively few lines of code are changed by a code unit 124(1) and thus the change is quite small, a corresponding entity 126(1) may be “new” to the repository and the changes may involve a sensitive area in operation of the executable code 118. Accordingly, a fault score 122 is generated by the fault probability module 120 that causes the code testing module 130 to flag the code unit 124(1) for extra validation, e.g., by specifying a particular reviewer with significant experience in that sensitive area.

In a second example scenario, a code unit 124(N) is authored by an entity 126(N) having a significant amount of previously bug-free contributions to a respective repository. Further, the code unit 124(N) involves a change involving data files and documentation that historically do not involve a subsequent fix. The fault score 122 is therefore generated by the fault probability module 120 to cause the code testing module 130 to perform little, if any, further testing of the code unit 124(N) in this example.

In a third example scenario, the entities 126(1)-126(N) are a group of engineers are actively involved in development of the executable code 118. The engineers are characterized according to a risk contribution of code units produced, respectively. Guidance is then offered by the code testing module 130 to develop skills of the engineers that consistently make high-risk contributions to the executable code 118. Other examples are also contemplated, including evaluation of potential reviewers as part of testing control by the code development system 116.

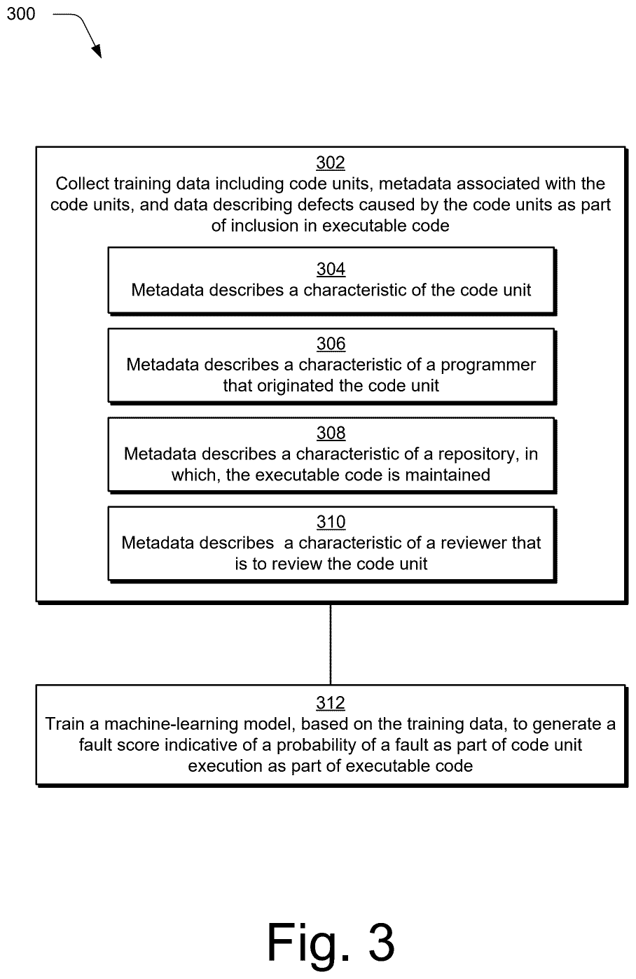

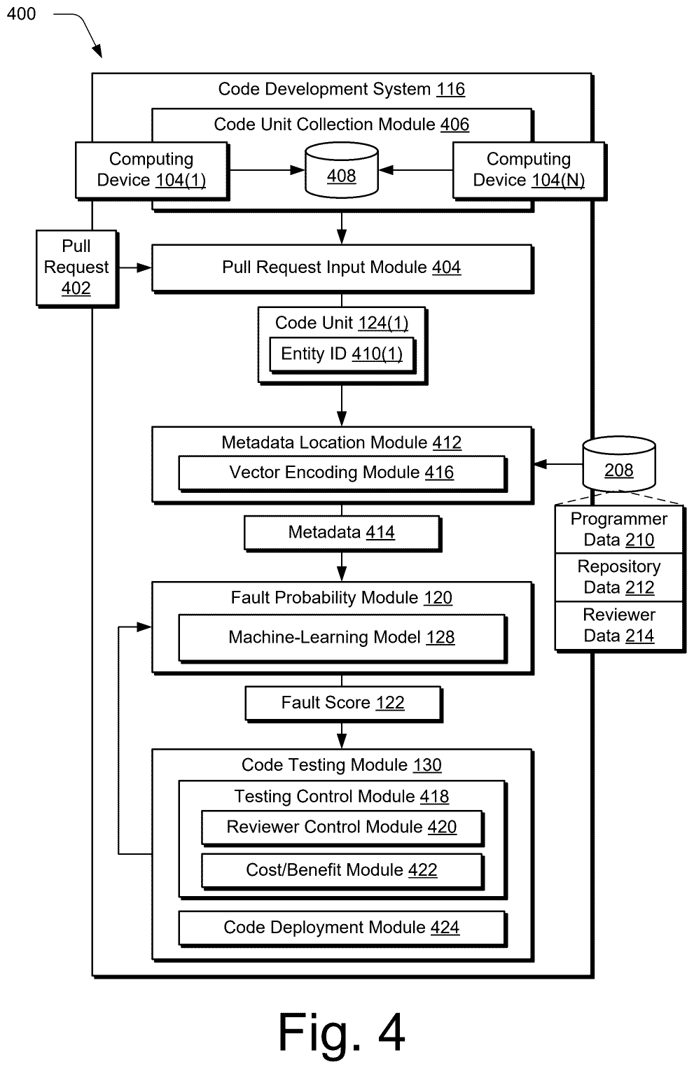

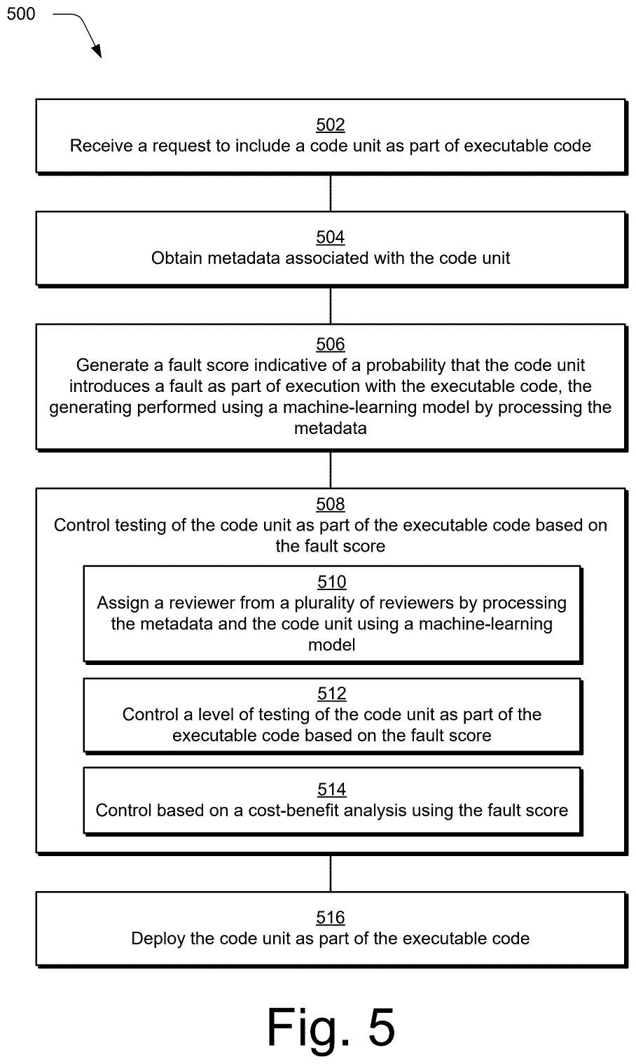

As a result, the code development system 116, through use of the fault probability module 120 and the code testing module 130, is usable to dynamically adapt review and quality gating as appropriate, which is not possible in conventional techniques. Further discussion of training of the machine-learning model 128 is described in relation to FIGS. 2 and 3 and use of the trained machine-learning model 128 is described in relation to FIGS. 4 and 5 in the following discussion.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Executable Code Fault Detection

The following discussion describes executable code fault detection techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 2 depicts a system 200 in an example implementation showing training of a machine-learning model 128 of FIG. 1 in greater detail. FIG. 3 is a flow diagram depicting an algorithm 300 as a step-by-step procedure in an example implementation of operations performable for accomplishing a result of training a machine-learning model for executable code fault detection. The following discussion is made in parallel to FIGS. 2 and 3.

To begin in this example, a training system 202 is employed to train the machine-learning model 128 of FIG. 1. The training system 202 is representative of functionality to generate training data, use the generated training data to train the machine-learning model, and/or use the trained machine-learning model as implementing the functionality described herein.

In order to train the model, a training data collection module 204 is employed by the training system 202 to collect training data 206, e.g., from one or more sources illustrated as a storage device 208. The training data 206 includes code units and metadata associated with the code units as part of inclusion in executable code (block 302). The training data 206, for instance, may be collected from a repository that describes previously monitored interactions involving code units, which may include fixes to the code units and subsequent deployment of the code units.

Accordingly, the training data is configurable to describe a variety of characteristics associated with the code units, examples of which include a characteristic of the code unit, a characteristic of a programmer that originated the code unit, a characteristic of a repository, in which, the executable code is maintained, a characteristic of a reviewer that is to review the code unit, and so forth. Metadata describing a characteristic of the code unit (block 304), for example, includes a size of a change, a file involved with the code unit, a risk level associated with a corresponding function involved in execution of the code unit, or an issue type associated with the code unit.

In another example, programmer data 210 describes characteristics of a programmer that originated the code unit (block 306). The programmer data 210, for instance, is usable to describe an experience level of the programmer, a risk level of previous code unit originated by the programmer, a defect history associated with the programmer, an amount of code units originated by the programmer for a repository, or an acceptance rate of incorporation of previous code units by the programmer.

In an additional example, repository data 212 describes a characteristic of a repository, in which, the executable code is maintained (block 308). The repository data 212, for instance, describes a rate of fixes to faults corrected for respective items of executable code maintained in the repository or a total number of items of executable code maintained in the repository. In a further example, reviewer data 214 describes a characteristic of a reviewer that is to review the code unit (block 310). The reviewer data 214 includes a number of previous code units reviewed by the reviewer or accuracy of previous reviews by the reviewer. A variety of other examples are also contemplated.

The machine-learning model 128 is then trained by a training module 216 of the training system 202 based on the training data 206 to generate a fault score indicative of a probability of a fault as part of code unit execution as part of the executable code (block 312). A machine-learning model 128, as previously described, refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, large language models, classifiers, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In the illustrated example, the machine-learning model 128 is configured using a plurality of layers 220(1), . . . , 220(N) having, respectively, a plurality of nodes 222(1), . . . , 222(N). The plurality of layers 220(1)-220(N) are configurable to include an input layer, an output layer, and one or more hidden layers. Calculations are performed by the nodes 222(1)-222(N) within the layers via hidden states through a system of weighted connections that are “learned” during training of the machine-learning model 128 to implement a variety of tasks.

In order to train the machine-learning model 128, the training data 206 is collected that provides examples of “what is to be learned” by the machine-learning model 128, i.e., as a basis to learn patterns from the data. The training system 202, for instance, collects and preprocesses the training data 206 that includes input features and corresponding target labels, i.e., of what is exhibited by the input features. The training module 216 then initializes parameters of the machine-learning model 128, which are used by the machine-learning model 128 as internal variables to represent and process information during training and represent interferences gained through training. In an implementation, the training data 206 is separated into batches to improve processing and optimization efficiency of the parameters of the machine-learning model 128 during training.

The training data 206 is then received as an input by the machine-learning model 128 and used as a basis for generating predictions based on a current state of parameters of layers 220(1)-220(N) and corresponding nodes 222(1)-222(N) of the model, a result of which is output as output data 218. Output data 218 describes an outcome of the task, e.g., as a probability of introducing a fault in this example.

Training of the machine-learning model 128 includes calculating a loss function 224 to quantify a loss associated with operations performed by nodes of the machine-learning model 128. The calculating of the loss function 224, for instance, includes comparing a difference between predictions specified in the output data with target labels specified by the training data 206, e.g., whether a fault did or did not occur. The loss function 224 is configurable in a variety of ways, examples of which include regret, Quadratic loss function as part of a least squares technique, and so forth.

Calculation of the loss function 224 also includes use a backpropagation operation 226 as part of minimizing the loss function 224 and thereby training parameters of the machine-learning model 128. Minimizing the loss function 224, for instance, includes adjusting weights of the nodes 222(1)-222(N) in order to minimize the loss and thereby optimize performance of the machine-learning model 128 in performance of a particular task. The adjustment is determined by computing a gradient of the loss function 224, which indicates a direction to be used in order to adjust the parameters to minimize the loss. The parameters of the machine-learning model 128 are then updated based on the computed gradient.

This process continues over a plurality of iterations in an example until a stopping criterion 228 is met. The stopping criterion 228 is employed by the training system 202 in this example to reduce overfitting of the machine-learning model 128, reduce computational resource consumption, and promote an ability of the machine-learning model 128 to address previously unseen data, i.e., that is not included specifically as an example in the training data 206. Examples of a stopping criterion 228 include but are not limited to a predefined number of epochs, validation loss stabilization, achievement of a performance improvement threshold, or based on performance metrics such as precision and recall. The machine-learning model 128, once trained, is then usable to generate a fault score for code units as further described below.

FIG. 4 depicts a system 400 in an example implementation showing executable code fault detection by a machine-learning model as trained in FIG. 2 in greater detail. FIG. 5 is a flow diagram depicting an algorithm 500 as a step-by-step procedure in an example implementation of operations performable for accomplishing a result of executable code fault detection and review control. The following discussion is made in parallel to FIGS. 4 and 5.

To begin in this example, a request is received to include a code unit 124(1) as part of executable code 118 (block 502). A pull request 402, for example, is received by a pull request input module 404 that is associated with credentials (e.g., as verified by the pull request input module 404) to initiate incorporation of the code unit 124(1) as part of the executable code 118. In response, the code unit 124(1) is obtained by the pull request input module 404 from a code unit collection module 406. The code unit collection module 406, for instance, communicates with a repository 408 that is configured to maintain the code unit 124(1) for execution and development by entities 126(1)-126(N) associated with respective computing devices 104(1)-104(N) using an isolated (e.g., sandboxed) branch of the executable code 118.

The code unit 124(1) in the illustrated example includes an entity ID 410(1) of a respective entity 126(1) (e.g., programmer) that originated the code unit 124(1), which is passed as an input to a metadata location module 412. The metadata location module 412 is then employed to obtain metadata 414 associated with the code unit 124(1) (block 504).

The metadata 414 is configurable to describe a variety of characteristics associated with the code unit 124(1), examples of which include a characteristic of the code unit, a characteristic of a programmer that originated the code unit, a characteristic of a repository, in which, the executable code is maintained, a characteristic of a reviewer that is to review the code unit, and so forth. Metadata 414 describing a characteristic of the code unit 124(1), for example, includes a size of a change, a file involved with the code unit, a risk level associated with a corresponding function involved in execution of the code unit, or an issue type associated with the code unit.

In another example, programmer data 210 describes characteristics of a programmer that originated the code unit, which is located based on the entity ID 410(1). The programmer data 210, for instance, is usable to describe an experience level of the programmer, a risk level of previous code unit originated by the programmer, a defect history associated with the programmer, an amount of code units originated by the programmer for a repository, or an acceptance rate of incorporation of previous code units by the programmer.

In an additional example, repository data 212 is located from the storage device 208 that describes a characteristic of a repository, in which, the executable code 118 is maintained. The repository data 212, for instance, describes a rate of fixes to faults corrected for respective items of executable code maintained in the repository or a total number of items of executable code maintained in the repository. In a further example, reviewer data 214 describes a characteristic of a reviewer that is to review the code unit (block 310). The reviewer data 214 includes a number of previous code units reviewed by the reviewer or accuracy of previous reviews by the reviewer. The reviewer data 214 is also configurable to describe previous reviews of similar types of code units. A variety of other examples are also contemplated. In an implementation, the metadata 414 is encoded as an input vector using a vector encoding module 416 so as to be consumable by a machine-learning model 128.

A fault probability module 120 accepts as an input the metadata 414 (e.g., in vector form) for processing to generate a fault score 122 indicative of a probability that the code unit 124(1) introduces a fault as part of execution with the executable code 118. The fault score 122 is generated by the fault probability module 120 using a machine-learning model 128 by processing the metadata 414 (block 506), which may be performed independent of or along with the code unit 124(1) itself.

The machine-learning model 128, as described in relation to FIG. 2, is trained to learn an interplay between the inputs as defined in the metadata 414 and how these inputs correlate with a probable outcome of execution of the code unit 124(1), i.e., whether execution is likely to result in a fault which is also known as a “bug.” The probability expressed by the fault score 122, for instance, may be implemented similar to probability assigned by a classifier as expressing a likelihood that the fault will or will not occur.

Testing of the code unit 124(1) as part of the executable code 118 is controlled based on the fault score 122 (block 508) by the code testing module 130. In a first example, a reviewer is assigned from a plurality of reviewers by processing the metadata and the code unit using a machine-learning model (block 510). A testing control module 418, for instance, utilizes a machine-learning model by as part of a reviewer control module 420 to process data describing the reviewers and testing previously undertaken by the reviewers, e.g., type of code unit, associated level or risk, accuracy of fixes specified by the review and so on. The data is processed along with the metadata 414 and/or the code unit 124(1), itself, to locate the reviewer, e.g., based on a similarity metric such as Cosine similarity of vectors describing the reviewer in relation to the metadata 414 and/or the code unit 124(1).

In a second example, a level of testing of the code unit 124(1) is controlled by testing control module 418 as part of executable code 118 based on the fault score 122 (block 512). The fault score 122, for instance, may indicate a level of riskiness, “newness” of a programmer that originated the code unit 124(1), and so on and assign a level of testing accordingly. The level of testing may indicate a number of reviewers, an experience level of the reviewers, use of automated testing techniques having varying degrees of investigation and corresponding different levels of computational resource consumption, and so forth.

In a third example, testing is controlled by the testing control module 418 based on a cost/benefit analysis using the fault score 122 (block 514) by a cost/benefit module 422. A cost/benefit analysis, for instance, may be used to!balance an amount of risk associated with a fault, potential losses caused by the fault, and so forth with a cost associated with review of the fault by reviewers, automated tools, and so forth. In this way, the testing control module 418 optimizes utilization of human resources and computational resources in testing the code unit 124(1) for incorporation as part of the executable code 118. Once tested and faults corrected, the code unit 124(1) is then deployed by a code deployment module 424 as part of the executable code 118 (block 516), e.g., for inclusion as part of the digital services 112 that are made accessible via the network 106.

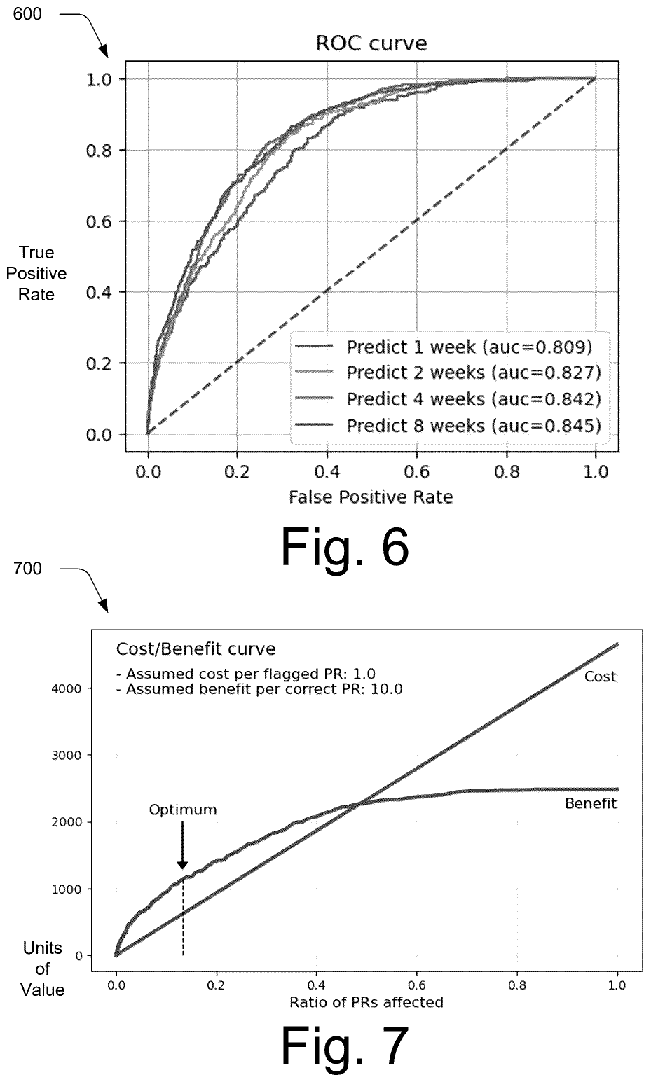

FIG. 6 depicts an example implementation 600 of a receiver operating character curve. In an implementation, the machine-learning model 128 is configured as a histogram gradient boosting classifier to generate the fault score 122 as a predication of a likelihood that a pull request (PR) will involve a fault and subsequent correction. A dataset is built from 18,593 total pull requests in this example taken from two large, independent repositories (containing 8,729 and 9,864 pull requests), with seventy-five percent of the data uniformly chosen at random used for training, leaving a dataset of 4,649 pull requests as the unseen testing data for evaluation. Each pull request is flagged according to whether contributed lines of code are modified by a subsequent corrective pull request, e.g., within some given time horizon. Corrective pull requests are detected by either analysis of the pull request's title, via the issue type data from an associated ticket, and so forth.

The machine-learning model 128 outputs the fault score 122 as having a value between “0” and “1” giving the probability as an estimated likelihood that a pull request is modified, subsequently, by a corrective pull request. Examples of metadata 414 supplied to the machine-learning model 128 include:
A number of reviewers that have been assigned to approve the pull request;
A binary flag indicating if the pull request is itself a correction;
A programmer's (i.e., author's) total number of pull requests authored and reviewed in the repository;
A ratio of the programmer's (i.e., author's) previous pull requests that are flagged for subsequent correction;
A mean and standard deviation of the number of the comments on the author's previous pull requests;
Statistics (min, mean, standard deviation, max) of the reviewers':
   Total pull requests authored and reviewed within the repository;
   Ratio of their previously authored and reviewed pull requests that involve a correction; and
   A number of comments given and received on previously authored and reviewed pull requests;
Statistics (min, mean, standard deviation, max) of the files changed by the pull request:
   Total additions and deletions;
   Binary flags indicating if the files are classified as either data, documentation, or code; and
   Total changes made in each file's history, and the total changes made due to corrective pull requests.

In an implementation, multiple machine-learning models are trained to predict whether a pull request is fixed within a timeframe of one, two, four, or eight weeks. Over those time horizons in the dataset, 5.3%, 7.5%, 9.9%, and 12.8% of pull requests are modified by a correction respectively in this example. The machine-learning models are evaluated on the unseen test set, and the resulting receiver operating characteristic (ROC) curve for each model is depicted in FIG. 6.

The machine learning model's output may be tuned according to a desired level of accuracy by choosing a point along the ROC curve. For example, around 90% of pull request are identifiable as involving a subsequent correction with a 40% false positive rate. Whereas 20% of corrected pull requests can be detected with a smaller false positive rate of a few percent. As the average cost of a fault may be high, preventing twenty percent of potential faults delivers significant value.

The code development system 116 is therefore usable to support a variety of functionality, such as to specify additional checks for those pull requests deemed high risk by the machine-learning model 128. The machine-learning model 128 can be tuned so that a certain percentage of pull requests are flagged, with administrators utilizing a cost/benefit curve 700 to decide upon the sensitivity as shown in FIG. 7. The area above the curve 700 shows the expected benefits relative to the costs for the model predicting when a pull request involves a subsequent correction within one week. In this analysis, the cost of the additional action is set at “1.0,” while the benefit to correctly preventing a fault is valued at “10.”

The curve 700 of FIG. 7 shows a clear optimum value that maximizes benefit relative to cost, but it is robust enough to offer net benefit outside of the optimum as well. For some repositories the value of preventing a fault from being merged into the production codebase may be far higher than ten times the cost of a preventative measure, meaning that the benefit increases commensurately.

The machine-learning model 128 is also configurable to permit interrogation by way of modification of the input. The fault score 122 is affected by factors such as the author's and reviewers' experience, size of the pull request, types of files that are affected, and so forth. Simple recommendations may be constructed by the code development system 116 based upon these modifications. For example:
Removing file “xjson” from the pull request reduces risk by 10%;
This pull request is in the top 25% of risk values and therefore reducing the number of changes from “X” to “Y” is recommended; or
Adding reviewer “R” to this pull request reduce the fault score 122 from “0.35” to “0.15.”

In this way, the code development system 116 is configurable to generate a fault score 122 that codifies an inherent statistical risk likely to occur from a change caused by a code unit 124(1) and may do so without executing the executable code 118 itself. The code development system 116 may even do so in one or more examples independent of analysis of the code unit 124(1), itself, solely through analysis of the metadata 414, although analysis of the code unit 124(1) is also supported as described above.

### Example System and Device

FIG. 8 illustrates an example system generally at 800 that includes an example computing device 802 that is representative of one or more computing systems and/or devices that implement the various techniques described herein. This is illustrated through inclusion of the code development system 116. The computing device 802 is configurable, for example, as a server of a service provider, a device associated with a client (e.g., a client device), an on-chip system, and/or any other suitable computing device or computing system.

The example computing device 802 as illustrated includes a processing device 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 804 is representative of functionality to perform one or more operations using hardware. Accordingly, the processing device 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812 that stores instructions that are executable to cause the processing device 804 to perform operations. The computer-readable storage medium is configured for storing instructions that, responsive to execution by the processing device, causes the processing device to perform operations. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing device 804. The instructions and/or functions are executable/operable by one or more articles of manufacture (for example, one or more computing devices 802 and/or processing devices 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

In implementations, the platform 816 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a request to include a code unit as part of executable code;
obtaining, by the processing device, metadata associated with the code unit;
generating, by the processing device, a fault score indicative of a probability that the code unit introduces a fault as part of execution with the executable code, the generating performed using a machine-learning model by processing the metadata; and
controlling, by the processing device, testing of the code unit as part of the executable code based on the fault score.

2. The method as described in claim 1, wherein the generating of the fault score by the machine-learning model is performed independent of the code unit.

3. The method as described in claim 1, wherein the generating of the fault score by the machine-learning model is performed by processing the metadata and the code unit.

4. The method as described in claim 1, wherein the metadata describes a characteristic of the code unit, a characteristic of a programmer that originated the code unit, a characteristic of a repository, in which, the executable code is maintained, or a characteristic of a reviewer that is to review the code unit.

5. The method as described in claim 4, wherein the characteristic is the characteristic of the code unit that includes a size of a change, a file involved with the code unit, a risk level associated with a corresponding function involved in execution of the code unit, or an issue type associated with the code unit.

6. The method as described in claim 4, wherein the characteristic is the characteristic of a programmer that originated the code unit and includes an experience level of the programmer, a risk level of previous code unit originated by the programmer, a defect history associated with the programmer, an amount of code units originated by the programmer for a repository, or an acceptance rate of incorporation of previous code units by the programmer.

7. The method as described in claim 4, wherein the characteristic is the characteristic of a repository, in which, the executable code is maintained includes a rate of fixes to faults corrected for respective items of executable code maintained in the repository or a total number of items of executable code maintained in the repository.

8. The method as described in claim 4, wherein the characteristic is the characteristic of the reviewer that is to review the code unit includes a number of previous code units reviewed by the reviewer or accuracy of previous reviews by the reviewer.

9. The method as described in claim 1, wherein the controlling includes assigning a reviewer from a plurality of reviewers by processing the metadata and the code unit using a machine-learning model.

10. The method as described in claim 1, wherein the controlling includes controlling a level of testing of the code unit as part of the executable code based on the fault score.

11. The method as described in claim 10, wherein the level of testing specifies a number of reviewers to be assigned to test the code unit.

12. The method as described in claim 1, wherein the controlling including controlling based on a cost/benefit analysis using the fault score based on a cost associated with a review and a cost associated with the fault.

13. A computing device comprising:
a processing device; and
a computer-readable storage medium storing instructions that, responsive to execution by the processing device, causes the processing device to perform operations including:
receiving a request to include a code unit as part of executable code;
obtaining metadata associated with the code unit;
assigning a reviewer from a plurality of reviewers by processing the metadata and the code unit using a machine-learning model; and
controlling testing of the code unit as part of the executable code based on the assigned reviewer.

14. The computing device as described in claim 13, wherein the assigning by the machine-learning model is based, at least in part, on review data describing previous reviews performed, respectively, by the plurality of reviewers.

15. The computing device as described in claim 14, wherein the review data describes a number of previous code units reviewed by a respective said reviewer or accuracy of previous reviews by the respective said reviewer.

16. One or more computer-readable storage media storing instructions that, responsive to execution by a processing device, causes the processing device to perform operations comprising:
collecting training data including code units, metadata associated with the code units, and data describing defects caused by the code units as part of inclusion in executable code; and
training a machine-learning model, based on the training data, to generate a fault score indicative of a probability of a fault as part of code unit execution.

17. The one or more computer-readable storage media as described in claim 16, wherein the metadata describes a characteristic of the code unit, a characteristic of a programmer that originated the code unit, a characteristic of a repository, in which, the executable code is maintained, or a characteristic of a reviewer that is to review the code unit.

18. The one or more computer-readable storage media as described in claim 17, wherein the characteristic includes a size of a change, a file involved with the code unit, a risk level associated with a corresponding function involved in execution of the code unit, or an issue type associated with the code unit.

19. The one or more computer-readable storage media as described in claim 17, wherein the characteristic includes an experience level of the programmer, a risk level of previous code unit originated by the programmer, a defect history associated with the programmer, an amount of code units originated by the programmer for a repository, or an acceptance rate of incorporation of previous code units by the programmer.

20. The one or more computer-readable storage media as described in claim 17, wherein the characteristic includes a rate of fixes to faults corrected for respective items of executable code maintained in the repository or a total number of items of executable code maintained in the repository.
